(19) United States
(12) Patent Application Publication
(10) Pub. No.: US 2010/0087140 A1
(43) Pub. Date: Apr. 8, 2010

(54) Method for Enhancing Communication, a Terminal and a Telecommunication System

(75) Inventors: Mikko MAKIPAA, Helsinki (FI); Toni KOPRA, Vantaa (FI)

Correspondence Address: Hollingsworth & Funk, 8500 Normandale Lake Blvd., Suite 320, Minneapolis, MN, 55437, US

(73) Assignee: Nokia Corporation

(21) Appl. No.: 12/433,326

(22) Filed: Apr. 30, 2009

Related U.S. Application Data
(63) Continuation of application No. 10/841,888, filed on May 7, 2004, now abandoned.

(51) Int. Cl. H04H 40/00

(52) U.S. Cl. 455/3.06

(57) ABSTRACT

A solution for enhancing communication in a telecommunication system is provided. In the solution, data concerning a dynamic profile of at least some of the terminals of the system is maintained in the system. The data is available to other terminals. When music is played in a terminal the dynamic profile of the terminal is updated with information relating to the music played in the terminal.

### RELATED APPLICATIONS

This application is a continuation of prior application Ser. No. 10/841,888, filed May 7, 2004, the content of which is incorporated herein by reference in its entirety.

### FIELD

The invention relates to a method for enhancing communication in a telecommunication system where terminals of the system maintain a dynamic profile in the system.

### BACKGROUND

The most common service offered to the users, by telecommunication systems has been for a long time an ordinary call from one person to another, or what is known as a point-to-point connection. Lately the operators of telecommunication systems have offered numerous new services which enhance the usage of terminals in telecommunication systems.

A service that has been created recently is what is known as the use of presence information. Presence information refers to a kind of dynamic profile that the user publishes and that is available to the users that have subscribed the service. The information may comprise, for instance, data about the availability of the user and about the type of data transmission the terminal of the user supports. The data concerning all the subscribers utilizing the service is typically maintained in a server of the system, from where the user profiles that the subscribers desire can be moved into the terminal of each subscriber. Thus, the subscriber may for instance observe from the address book of the terminal the profile of the users he/she desires, which profile may comprise for instance data about whether the user concerned is available at that particular moment. From this, the subscriber may deduce whether it is worth calling the user in question at that moment.

The present methods of communication through telecommunication systems are limited regarding expressing emotions. It is possible to send a separate text message or make a phone call in order to express different emotions to another. This way of communication may sometimes be cumbersome, as it requires specific actions from the user.

### BRIEF DESCRIPTION OF THE INVENTION

An object of the invention is to provide an improved solution for enhancing communication. According to an aspect of the invention, there is provided a method for enhancing communication in a telecommunication system, the method comprising: maintaining data in the system, concerning a dynamic profile of at least some of the terminals of the system, the data being available to other terminals, and when music is played in a terminal updating the data in the system with information relating to the music played in the terminal.

According to another aspect of the invention, there is provided a telecommunication system, comprising: means for maintaining data in the system, concerning a dynamic profile of at least some of the terminals of the system, the data being available to other terminals, and when music is played in a terminal means for updating the data in the system with information relating to the music played in the terminal.

According to another aspect of the invention, there is provided a terminal in a telecommunication system, the terminal comprising: means to download from the system data concerning a dynamic profile of another terminal of the system, the data comprising information characterizing music if music is currently played in the other terminal; a display to display the dynamic profile of the other terminal; and means to utilize information characterizing music played in the other terminal when displaying the dynamic profile of the other terminal.

The invention provides several advantages. Modern terminals are capable of playing music in various formats. Users usually listen to music tracks that are in harmony with their current mood or feelings. In an embodiment of the invention, information about the characteristics of music tracks played in the terminal is included in the dynamic profile or presence information stored in the system to which terminal is attached. Users who subscribe the dynamic profile receive also this information. The user playing music may thus share his/her feelings and moods with those he/she wishes without taking specific actions.

### LIST OF DRAWINGS

In the following, the invention will be described in greater detail with reference to the embodiments and the accompanying drawings, in which

FIG. 1 shows an example of a telecommunication system;

FIG. 2 illustrates an example of a terminal;

FIGS. 3A to 3D illustrate embodiments of the invention with flowcharts;

FIGS. 4A and 4B illustrate examples of views of an address book application; and

FIG. 5 illustrates an example of an electronic device.

### DESCRIPTION OF EMBODIMENTS

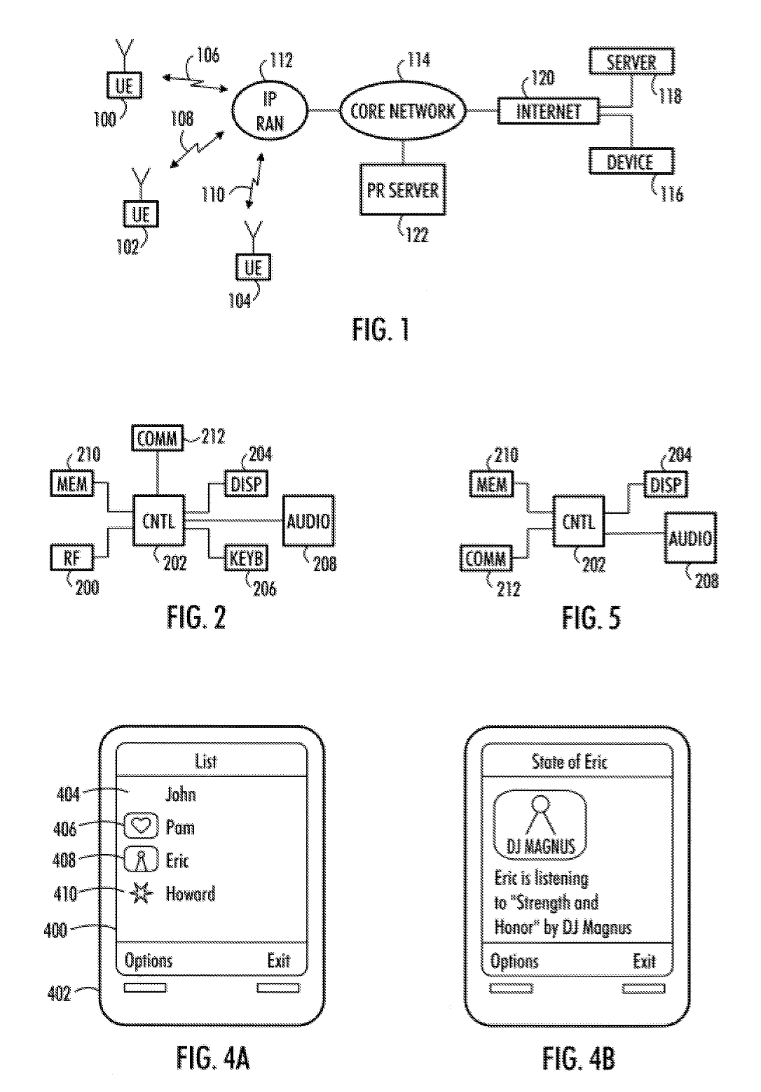

Referring to FIG. 1, let us study an example of a telecommunication system, to which some of the embodiments of the invention can be applied. The system of FIG. 1 comprises a set of terminals 100 to 104 capable of having connection 106 to 110 to the rest of the system through a radio access network 112. The connection between the terminals and the system is not necessarily a wireless connection, but an apparatus utilizing a wired connection can also be concerned. The access network may be realized using the UTRA (Universal Terrestrial Radio Access) of UMTS (Universal Mobile Telecommunication System) or a GPRS (General Packet Radio Service) based network or other similar services offering the arrangement. The radio access network 112 is provided with a connection to a core network 114. The core network provides connections between terminals and connections to devices 116 or servers 118 in external networks, such as the Internet 120.

The system comprises a server 122 maintaining dynamic profiles. A dynamic profile, or presence information, refers to information that may comprise for instance data concerning the availability and the location of the user, and the type of data transmission supported by the user of the terminal. In addition, servers 118 in external networks and external applications to be driven therein may publish a profile depicting them.

Let us take an example in order to illustrate such a case. The user of the terminal 100 determines desired profile information and transfers 106 the profile to the server 122 through the radio access network 112, and the core network 114. At the same time, the user may define to whom the information in the server is available. The user may define which parts of the profile are available to different user groups.

The user of the terminal 102 may order the profile of said user 100 from the server 122 to a terminal 102, in which case always when the profile in the server is updated, the updated information is conveyed to the terminal 102.

The user of the terminal 104 may send a single inquiry regarding the profile of said user 100 from the terminal 104 to the server 116 and may be provided with the current profile.

Referring to FIG. 2, let us take a closer look at an example of a terminal to which some of the embodiments of the invention can be applied. The terminal comprises radio frequency parts 200, which allows the terminal to communicate with the radio access network. The radio frequency parts can be implemented in known manners. The terminal also comprises a control unit 202 that controls the operation of the terminal. The control unit 202 can be implemented using a processor or separate logic and software. The terminal further comprises a display 204 that may be used to show information to the user, a keyboard 206 with which the user may provide the terminal with commands and audio parts 208 composed of a microphone and an earpiece and/or a speaker. The keyboard 206 may also comprise a control stick or another user interface. The display 204 of the terminal may also be a touch screen that allows the apparatus to be provided with commands. The terminal may also comprise other communication units 212, such as a short distance communication unit implemented with Bluetooth technology or infrared, and WLAN (Wireless Local Area Network) communication unit.

The terminal also comprises a memory 210, in which various data can be stored. In practice, the memory 210 may be implemented with one or more physical or logical memory units. The memory may also be partly detachable. Part of the memory may be a memory unit in the terminal, and part of the memory may be realized with a removable memory card. The data may comprise an application which can be executed in the terminal and data relating to the applications. For example, the terminal may execute an address book application. The address book application and related information may be stored in a memory 219. The information may comprise personal information, names and contact data, such as telephone numbers. The memory may also include data about the dynamic profiles of other users and the service providers in the system ordered by the user.

As the dynamic profile changes in the server 122 of the system maintaining profiles, the server may be configured to send an update message to a terminal which subscribed the profile. The message may be sent using control channels, for instance. The control unit 202 of the terminal is arranged to receive the update information and to update profiles stored in the memory 210.

The terminal may be configured to execute an application which plays music tracks using the audio parts 208. The music tracks may be stored in the memory 210 of the terminal. The application may also be configured to play music tracks streamed from a server in the system.

In an embodiment, the terminal is configured to store parameters characterizing the music tracks played in the terminal. The parameters may comprise the name of the music track, the name of the artist performing the music, genre of the music, tempo of the music, mood of the music, or an identification tag of the music track, for example. The genre of a music track may describe the musical style of the track. The tempo of a music track may illustrate the rhythm of the track. The mood of a music track may illustrate the general impression or feeling the track arouses in a listener. An identification tag of the music track may be a unique ID for each track. The tag may be defined by the publisher or the distributor of the music track. In an embodiment ISRC (International Standard Recording Code) is used as a tag. ISRC is an international identification system for recordings. Each ISRC is a unique and permanent identifier for a specific recording. The tag may also be defined by the distributor or vendor of the music track.

The parameters characterizing the music tracks may be stored in the same file as the music track. The parameters may also be stored in a separate database.

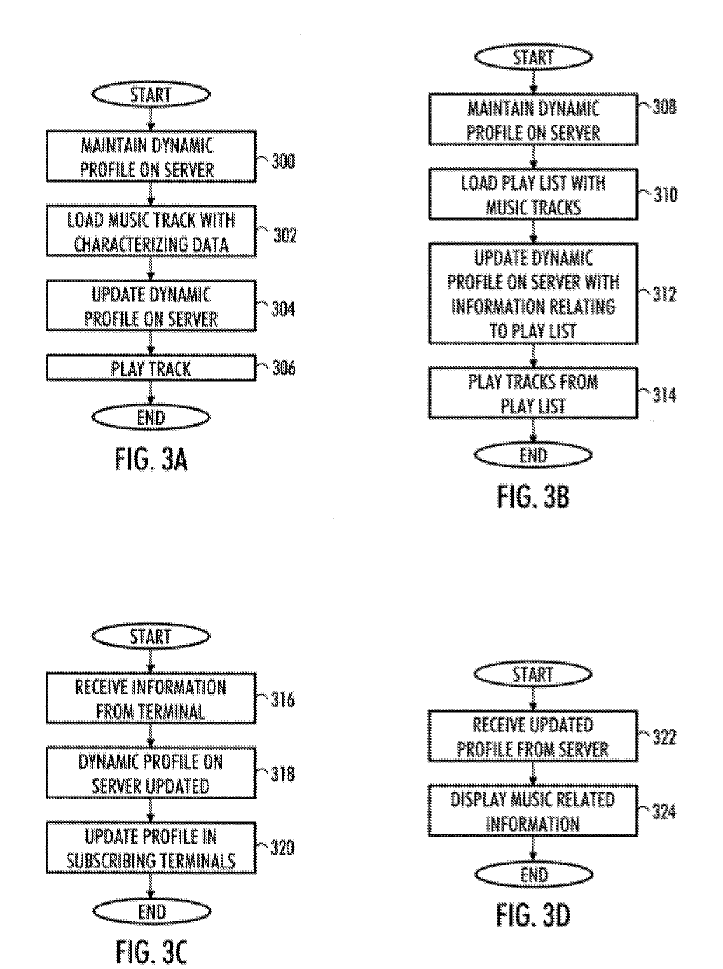

The flowcharts of FIGS. 3A to 3D illustrate embodiments of the invention. In the embodiment of FIG. 3A, a terminal maintains a dynamic profile on a server 122 of the system in step 300. In step 302, the terminal loads a music track from the memory 210. Parameters characterizing the music track are also loaded. In step 304, the parameters or information about the parameters are sent to the server 122, which updates the dynamic profile of the terminal on the basis of the information. In step 306, the track is played in the terminal. In practice, steps 304 and 306 may be executed simultaneously.

In the embodiment of FIG. 3B, a terminal 100 maintains a dynamic profile on a server 122 of the system in step 308. This step is similar to the one in the previous embodiment. In step 310, the terminal loads a play list comprising music tracks from the memory 210. Parameters characterizing the play list are also loaded. The parameters characterizing the play list may represent an aggregate of parameters of the tracks in the play list. In step 312, the parameters or information about the parameters are sent to the server 122, which updates the dynamic profile of the terminal on the basis of the information. In step 314, the terminal starts playing tracks from the play list. As in the previous example, steps 312 and 314 may be executed simultaneously.

Referring to the embodiment of FIG. 3C, in step 316 the server 122 maintaining dynamic profiles of terminal users receives information from a terminal relating to the dynamic profile of the terminal. This information was transmitted from the terminal in steps 304 or 312 described above. The information may be parameters describing a track or a play list to be played in the terminal. It may thus comprise information about the name of the currently played music track, the name of the artist performing the music, genre of the music, tempo of the music, mood of the music or identification tag of a music track, for example.

In an embodiment, the information is transferred as such. In another embodiment the information is coded in such a way that the amount of data transmitted may be reduced. Thus, a given code or symbol may denote a given genre and another code or symbol may denote another genre. Both the terminal and the server use similar codes or symbols to denote similar parameters.

In step 318, the dynamic profile of the terminal is updated with the received information. In step 320, the server checks if there are terminals or devices which have subscribed the dynamic profile. Subscribing a dynamic profile means that when the profile in the server is updated, the changes are sent also to the subscribers. Thus, if there are subscribers, the dynamic profile is updated also on these terminals and devices.

Referring to the embodiment of FIG. 3D, in step 322 a terminal receives an update to a subscribed dynamic profile. The update comprises information about the music tracks played on the terminal the profile describes. In step 324 the terminal stores the updated information and optionally displays the information on the display of the terminal. These steps may be performed by software in the control unit 202 of the terminal. The update may be received with the radio frequency part 200 or other communication units 212 of the terminal.

In an embodiment, graphical symbols, such as icons, may be linked with given information relating to music. These symbols may be preinstalled into the terminal memory. In an embodiment, the symbols are downloaded to the terminal from a server in the system. In an embodiment, the symbols are downloaded with the dynamic profile information. The symbols may be provided by the presence server or by a music distributor or vendor of the currently played track.

When a user of the terminal wishes to view dynamic profiles of another user, these graphical symbols may be used to enhance the usability of the operation. The user may execute a contact application or an address book application to view the dynamic profiles, for example. The application may display dynamic information of subscribed users directly. The user may also order a one-time profile of a user from the server 122 of the system.

When displaying the dynamic profile, the used application, such as an address book application, may select suitable graphical symbols to represent the status of the desired user. FIG. 4A illustrates an example of a view of an address book application in the display 400 of a terminal 402. The view shows four names: John, Pam, Eric and Howard with a graphical symbol beside the names. The symbol or icon beside each name graphically illustrates the music the user is listening using to his/her terminal. The icon 404 beside John's name is blank, indicating that John is not currently listening to any music. The icon 406 beside Pam's name is a heart, indicating that Pam is listening to romantic music. The icon 408 beside Eric's name is a picture of an artist, indicating that Eric is listening to music recorded by that artist. The icon 410 beside Howard's name is a star, indicating that Howard is listening to dance music, for example.

In an embodiment, the symbols or icons used in presenting music parameters may be animated. The animation may be controlled on the basis of the information relating to the music tracks. For example, the tempo of music may control the animation. The icon may have a defined animation cycle that can be controlled with animation parameters, such as speed of rotation, speed of pulsing, and number of elements per second. In the above example of FIG. 4A, the heart icon 406 may pulse in the tempo of the music Pam is listening to. Respectively, the star icon 410 may rotate and pulse, for example.

In an embodiment, color parameters of the icons or the display may be used to indicate different parameters of the dynamic profiles. For example, the color of the star icon 410 may indicate the genre of the music. The color of the icon or a part of the icon, other visual parameters, such as hue, alpha value or saturation, size or orientation of the icon, orientation or placement of the icon may be associated with different parameters of the dynamic profile. For example, the mood of current music can be associated with the color of the icon so that darker colors correspondingly represent darker moods.

In an embodiment, a distributor may offer graphical symbols with possible animations and variable color parameters to users of terminals. The distributor may maintain a server connected to a telecommunications system. The server is configured to store graphical symbols, related animations and adjustable visual parameters of the graphical symbols.

Thus, the user may download the graphical symbols and related animations from a distributor or a vendor. The user may send a purchasing inquiry to a server maintained by a distributor. The server is configured to respond to the inquiry and present the user a possibility to purchase graphical symbols.

The symbols may have predefined associations to a given music parameter. For example, a given graphical symbol or icon may be associated with rock music, and when a user downloads such a symbol and installs the symbol to the terminal, the terminal displays said symbol when the music genre of another user indicates that the user is playing rock music. In an embodiment, the user of the terminal may change the associations of the graphical symbols.

FIG. 4B illustrates another example of a view of an address book application in the display 400 of a terminal 402. The user of the terminal may select Eric from the view of FIG. 4A, and the address book application may be configured to represent a more detailed view of Eric's state as FIG. 4B illustrates. The view shows the icon 408 in a larger size and a text mode explanation of Eric's dynamic profile relating to the music played in Eric's terminal. The name of the track may be displayed on the display. The dynamic profile name may comprise the name of the track. The profile may also comprise an ID tag identifying the track, and the address book application may fetch the name from the system on the basis of the id tag.

In an embodiment, a selectable link is displayed on the display of a terminal, the link relating to the currently played track. The name of the track may be displayed as a link. The link may also be realized as a button “Buy this song”, for example. When the terminal detects that the user of the terminal has selected the link, the terminal may be configured to send an inquiry to a predefined music distributor or vendor with the identification tag of the track as a parameter and to present the user a possibility to buy and load the same track to the terminal 402. The predefined music distributor may maintain the server 118 in FIG. 1, for example.

In an embodiment, when the user of the terminal selects Eric from the view of FIG. 4A and the address book application represents a more detailed view of Eric's state, as FIG. 4B illustrates, the address book application is configured at this stage to contact the predefined music distributor or vendor of the music track and if the music track is available to display a selectable link on the display.

In an embodiment, the invention is realized in an electronic device which comprises a control unit 202, communicating means 212 connected to the control unit configured to communicate with another device, such as a terminal with Bluetooth technology, infrared, or WLAN (Wireless Local Area Network) communication unit. The device may further comprise a display 204, a memory 210 and audio parts which work in the same manner as in the terminal of FIG. 2.

In an embodiment, the invention is realized as a computer program product encoding a computer program of instructions for executing a computer process in a terminal or an electronic device of a telecommunication system for enhancing communication.

Even though the invention is described above with reference to an example according to the accompanying drawings, it is clear that the invention is not restricted thereto but it can be modified in several ways within the scope of the appended claims.

1. (canceled)

2. A method comprising:
receiving and maintaining data, in an electronic device of a telecommunication system, concerning a dynamic profile of at least a first terminal of the system, the data being available to at least a second terminal,
in response to receiving data characterizing a music track currently being played in the first terminal, updating the dynamic profile,
checking whether one or more terminals subscribe to the dynamic profile, and
in response to one or more terminals subscribing to the dynamic profile, transmitting data relating to the updated dynamic profile to the one or more subscribing terminals.

3. The method of claim 2, wherein the data characterizing the music track comprises at least one of the following:
the name of the currently played music track,
the name of the artist performing the music track,
the genre of the music track,
the tempo of the music track,
the mood of the music track,
a graphical symbol related to the music track, and
an identification tag of the music track.

4. The method of claim 3, wherein the data characterizing the music track is transmitted to the one or more subscribing terminals.

5. The method of claim 2, further comprising:
selecting graphical symbols on the basis of the data characterizing the music track, and
transmitting the selected symbols as part of the data relating to the updated dynamic profile.

6. The method of claim 5, further comprising:
selecting animations or visual parameters for graphical symbols on the basis of the data characterizing the music track, and
transmitting the animations or parameters as part of the data relating to the updated dynamic profile.

7. The method of claim 2, wherein the data relating to the updated dynamic profile comprises a selectable link relating to the music track.

8. The method of claim 2, wherein the music track currently being played is streamed from the electronic device.

9. A server of a telecommunication system, comprising a control unit and a memory storing executable instructions that, in response to execution by the control unit, cause the server at least to:
receive data from at least one terminal of the system concerning a dynamic profile corresponding to the terminal that transmitted the data, the data being available to one or more other terminals,
maintain the received data,
update the dynamic profile in response to receiving data characterizing a music track currently being played in the terminal that transmitted the data,
check whether one or more terminals subscribe to the dynamic profile, and
transmit data relating to the updated dynamic profile to one or more subscribing terminals.

10-16. (canceled)

17. A computer-readable medium encoded with a computer program of instructions for executing a computer process in an electronic device of a telecommunication system, the process comprising:
receiving data from at least a first terminal of the system, concerning a dynamic profile of the terminal from which the data was received, the data being available to one or more other terminals,
maintaining the received data,
in response to receiving data characterizing a music track currently being played in the terminal, updating the dynamic profile,
checking whether one or more terminals subscribe to the dynamic profile, and
in response to one or more terminals subscribing to the dynamic profile, transmitting data relating to the updated dynamic profile to the one or more subscribing terminals.

18-20. (canceled)

21. The server according to claim 9, wherein the data characterizing the music track comprises at least one of the following:
the name of the currently played music track,
the name of the artist performing the music track,
the genre of the music track,
the tempo of the music track,
the mood of the music track,
a graphical symbol related to the music track, and
an identification tag of the music track.

22. The server according to claim 21, wherein the memory and the control unit are configured to cause the server to transmit the data characterizing the music track to the one or more subscribing terminals.

23. The server according to claim 9, wherein the memory and the control unit are configured to cause the server to:
select graphical symbols on the basis of the data characterizing the music track, and
transmit the selected symbols as part of the data relating to the updated dynamic profile.

24. The server according to claim 9, wherein the memory and the control unit are configured to cause the server to:
select animations or visual parameters for graphical symbols on the basis of the data characterizing the music track, and
transmit the animations or parameters as part of the data relating to the updated dynamic profile.

25. The server according to claim 9, wherein the data relating to the updated dynamic profile comprises a selectable link relating to the music track.

26. The server according to claim 9, wherein the memory and the control unit are configured to cause the server to stream music and the music track currently being played is streamed from the server.

27. The server according to claim 9, wherein the memory and the control unit are configured to cause the server to transmit the data relating to the updated dynamic profile as an update message.

28. The computer-readable medium according to claim 17, wherein the data characterizing the music track comprises at least one of the following:
the name of the currently played music track,
the name of the artist performing the music track,
the genre of the music track,
the tempo of the music track,
the mood of the music track,
a graphical symbol related to the music track, and
an identification tag of the music track.

29. The computer-readable medium according to claim 28, wherein the data characterizing the music track is transmitted to the one or more subscribing terminals.

30. The computer-readable medium according to claim 17, wherein the process further comprises:
selecting graphical symbols on the basis of the data characterizing the music track, and
transmitting the selected symbols as part of the data relating to the updated dynamic profile.

31. The computer-readable medium according to claim 17, wherein the process further comprises:
selecting animations or visual parameters for graphical symbols on the basis of the data characterizing the music track, and
transmitting the animations or parameters as part of the data relating to the updated dynamic profile.
